(19) United States
(12) Patent Application Publication
(10) Pub. No.: US 2024/0283517 A1
(43) Pub. Date: Aug. 22, 2024

(54) CONTROL METHOD AND COMMUNICATION CONTROL DEVICE

(71) Applicant: NIPPON TELEGRAPH AND TELEPHONE CORPORATION, Tokyo (JP)

(72) Inventors: Shuki WAI, Musashino-shi, Tokyo (JP); Tatsuhiko IWAKUNI, Musashino-shi, Tokyo (JP); Daisei UCHIDA, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 18/271,992

(22) PCT Filed: Jan. 15, 2021
(86) PCT No.: PCT/JP2021/001252

§ 371 Date: Jul. 12, 2023

(51) Int. Cl. H04B 7/06; H04B 7/022

(52) U.S. Cl. CPC H04B 7/0695; H04B 7/022

(57) ABSTRACT

One aspect of the present invention is a control method of a communication control device for controlling communication of a plurality of base stations in a distributed antenna system, a control method, comprising: a selection step for selecting a beam for communication with a terminal station at some of a plurality of base stations; and an allocation step of allocating a candidate beam associated in advance with the beam selected by a selection step as the candidate beam in which base stations other than some of base stations perform communication with terminal stations.

### TECHNICAL FIELD

The present invention relates to a control method and technology of a communication control device.

### BACKGROUND ART

In a high frequency band such as a millimeter wave band or a terahertz band, the free space propagation loss is larger than that in a low frequency band such as a microwave band. For this reason, it is required to use a beamforming technique for forming a beam for concentrating power in a specific direction for compensation (for example, refer to Non Patent Literature 1).

In the case where the combination of wireless stations to be communicated is always fixed by P-P (Point-to-Point) type communication and the positional relation of the wireless stations and the propagation environment around the wireless stations are not changed, the beamforming can be performed fixedly in advance when the wireless stations are installed.

On the other hand, in the case of P-MP (Point-to-Multi Point) type accommodating a plurality of wireless stations, or in the case where at least one of the wireless stations to be communicated with each other moves, the beamforming cannot be performed fixedly. In this case, adaptive beamforming for adaptively controlling the direction of beam formation in accordance with the position of a wireless station requiring communication among a plurality of wireless stations, the movement of the wireless station, and the change of the propagation environment around the wireless station is required.

Since adaptive beamforming does not require a mechanical driving unit, it is generally performed by using a plurality of antenna elements and adjusting the phase relationship of radio waves radiated between the elements. However, in order to appropriately adjust the phase relationship, it is required to derive an appropriate phase relationship after grasping the phase relationship between the antenna elements of the wireless stations on the transmitting side and the receiving side. That is, it is required to grasp the state of the propagation path between each antenna element in all combinations of each antenna element between transmitting and receiving stations.

Although the state of the propagation path can be grasped by transmitting and receiving known signals between the transmitting and receiving stations, other communication cannot be performed during a period of the transmitting and receiving stations, and since the state of the propagation path must be accurately transmitted from the receiving station to the transmitting station, the overhead of the communication increases.

In order to suppress an increase in overhead, in adaptive beamforming, there is a technique of transmitting and receiving a signal including a beam ID associated with a plurality of candidate beams discretely set in advance by each candidate beam, and selecting a beam ID determined to be most suitable for communication from among the candidate beams. This technology has also been specified and implemented in wireless communication systems such as 3GPP 5G (5th Generation) and IEEE802.11ad, which have been put into practical use in recent years (see, for example, Non Patent Literatures 1, 2, and 3).

When a wireless station selects a transmitting beam, the wireless station generates a beam search signal in which a transmission beam ID that can uniquely identify each beam is embedded as digital information. The wireless station on the transmission side transmits the beam search signal by placing it on each beam generated by switching in time. Thus, the wireless station on the reception side measures the reception power of each beam, reads the transmission beam ID embedded in the beam search signal, determines which transmission side beam has good quality, and feeds back the transmission side beam to the wireless station on the transmission side to select the transmission side beam.

For the reception side beam selection of the wireless station, in a system such as TDD (Time Division Duplex) using the same frequency for transmission and reception, the same beam as the transmission side can be selected. However, in a system such as an FDD (Frequency Division Duplex) using a different frequency for transmission and reception, a wireless station on the receiving side requires to perform beam selection using a beam search signal, as in the case of beam selection in a wireless station on the transmitting side.

Since the beam search signal used for beam selection in the receiving side wireless station is generated by the wireless station on the transmitting side wireless station of the communication opposite party, a signal requesting transmission of the reception beam search signal is transmitted to the wireless station of the communication opposite party. The receiving side wireless station receives the beam search signal by switching the beam search signal temporally in accordance with the beam search signal transmitted from the wireless station of the communication partner, and determines which beam search signal quality is good by measuring the reception power, thereby selecting the receiving side beam.

Here, the beam search signal is, for example, SS (Synchronization Signal)/PBCH (Physical Broadcast CHannel) or CSI-RS (Channel State Information-Reference Signal), in 5G (for example, see Non Patent Literature 2).

FIG. 13 shows a general conventional configuration of a wireless communication system. A digital signal processing device for transmitting and receiving signals and one base station are connected, and one antenna is constituted in one cell. In this configuration, one base station is connected to one terminal station.

Here, as described above, since the beamforming technique is used in a high frequency band such as a millimeter wave band or a terahertz band, the influence of the reflected wave and the diffracted wave is reduced. Therefore, in a high frequency band, when the beam is shielded, the possibility of communication interruption becomes high, and the line-of-sight communication becomes a basic feature. In addition, the spatial correlation between a plurality of antennas for transmission and reception is increased in the MIMO (Multiple Input Multiple Output) technology which is effective as the spatial multiplexing technology, and the spatial multiplexing becomes difficult. MIMO is a technique in which a plurality of antennas is provided for transmission and reception, and the transmission rate is improved by a factor of the maximum number of antennas through spatial multiplexing using the same time and frequency resources.

In high frequency bands, a distributed antenna system that has effects of improving resistance to shielding and reducing spatial correlation are being studied (see, for example, Non Patent Literatures 4 and 5 and Japanese Patent Application Publication No. 2019-207210). FIG. 14 shows the configuration of a high frequency band distributed antenna system. A high frequency band distributed antenna system has a configuration in which a digital signal processing device for transmitting and receiving signals is connected to a plurality of base stations, and a plurality of distributed antennas are provided in one cell. In this configuration, one terminal station is connected from a plurality of distributed base stations.

As a result, spatial correlation is reduced by using MIMO technology between multiple antennas of one terminal station and antennas of multiple distributed base stations, enabling spatial multiplexing (single-user MIMO). However, in order to realize this, beam selection is indispensable for each link between the terminal station and the plurality of distributed antennas.

Here, a general transmission beam selecting method for performing high frequency band MIMO transmission will be described. First, a beam search signal in which a transmission beam ID associated with a plurality of candidate beams discretely set in advance by each transmission antenna of a wireless station and an antenna ID associated with each transmission antenna are embedded as digital information is temporally switched and transmitted on each transmission antenna and each transmission beam.

Then, the wireless station on the other side measures the reception power of each beam search signal by each reception antenna, reads the transmission beam ID and the antenna ID embedded in the beam search signal, and feeds back the pair of the transmission and reception antennas, the transmission beam ID and the reception quality to the wireless station on the transmission side. The wireless station receiving the transmission beam selects a plurality of transmission beams corresponding to the number of spatial multiplexing by MIMO from reception quality. In addition, the wireless station on the other side selects a plurality of reception beams, so that MIMO processing is performed between the plurality of transmission and reception beams, and high frequency band MIMO transmission is enabled.

In a cellular communication system to which a distributed antenna system is applied, a communication control device is provided to perform centralized control. The communication control device performs user scheduling, resource control and the like.

### CITATION LIST

### Non Patent Literature

Non Patent Literature 1: “5G multi-antenna technology” NTT DOCOMO Technical Journal, Vol. 23, No. 4, pp. 30-39, January 2016

Non Patent Literature 2: Kazuaki Takeda, et al., “Study status for technology for the physical layer and the high frequency band utilization in 5G”, NTT DOCOMO Technical Journal, Vol. 25, No. 3, pp. 23-32, October 2017

Non Patent Literature 3: Koji Takinami, et al., “Standardization trend and element technology of the millimeter wave bad wireless LAN system”, IEICE communication society magazine, No. 38, Autumn issue, pp. 100-106, 2016

Non Patent Literature 4: Uchida Daisei, et al., “A study of high-frequency band distributed antenna system in terminal high-density and shielded environments”, IEICE General Conference Proceedings of the Communication 1, B-5-87, pp. 375, March 2020

Non Patent Literature 5: Masashi Iwabuchi, et al., “Proposal of high-frequency band multi-path formation control by a large number and various of relay systems”, IEICE General Conference Proceedings of the Communication 1, B-5-101, pp. 389, March 2020

### SUMMARY OF INVENTION

### Technical Problem

In a high frequency band distributed antenna system in which a plurality of distributed antennas is arranged in one cell, it is required for one terminal station to perform beam search for each of the plurality of distributed antennas and select a plurality of beams. Therefore, in the high frequency band distributed antenna system, overhead for beam search corresponding to the number of distributed antennas increases, and the efficiency of data transmission decreases. That is, the overhead is increased by increasing the number of distributed antennas.

In view of the above circumstances, the present invention is an object of providing a technique for suppressing overhead occurring in a distributed antenna system.

### Solution to Problem

One aspect of the present invention is a control method of a communication control device for controlling communication of a plurality of base stations in a distributed antenna system, a control method comprising: a selection step for selecting a beam for communication with a terminal station at some of a plurality of base stations; and an allocation step of allocating a candidate beam associated in advance with the beam selected by the selection step as the candidate beam in which base stations other than some of the base stations perform communication with terminal stations.

One aspect of the present invention is a communication control device for controlling communication of a plurality of base stations in a distributed antenna system, a communication control device comprising: a selection unit for selecting a beam for communication with a terminal station at some of a plurality of base stations; and an allocation unit of allocating a candidate beam associated in advance with the beam selected by the selection unit as the candidate beam in which base stations other than some of the base stations perform communication with terminal stations.

### Advantageous Effects of Invention

According to the present invention, overhead occurring in the distributed antenna system can be suppressed.

### BRIEF DESCRIPTION OF DRAWINGS

FIG. 1 is an overall configuration diagram of a distributed antenna system in the present embodiment.

FIG. 2 is a diagram showing a connection example between a terminal station and a base station.

FIG. 3 is a block diagram showing a configuration of a communication device.

FIG. 4 is a diagram showing an example of combination information.

FIG. 5 is a diagram showing a beam example when beam #1 is selected as the beam for base station #1.

FIG. 6 is a flow chart showing the flow of processing for allocating transmission beams of a plurality of base stations to one terminal station.

FIG. 7 is a flow chart showing the flow of processing for allocating reception beams of a plurality of base stations to one terminal station.

FIG. 8 is a flow chart showing the flow of processing for allocating beam directions of beams transmitted by one terminal station to a plurality of base stations.

FIG. 9 is a flow chart showing the flow of processing for allocating beam directions of beams received by one terminal station to a plurality of base stations.

FIG. 10 is an example of combination information indicating the number of times of communication.

FIG. 11 is an example of combination information indicating the probability that a predetermined condition is satisfied.

FIG. 12 is an example of combination information further indicating the position of the terminal station.

FIG. 13 shows a general conventional configuration of a wireless communication system.

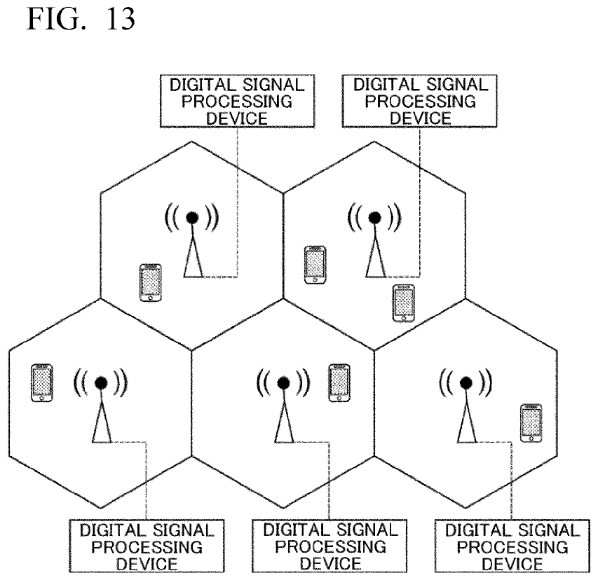

FIG. 14 shows the configuration of a high frequency band distributed antenna system.

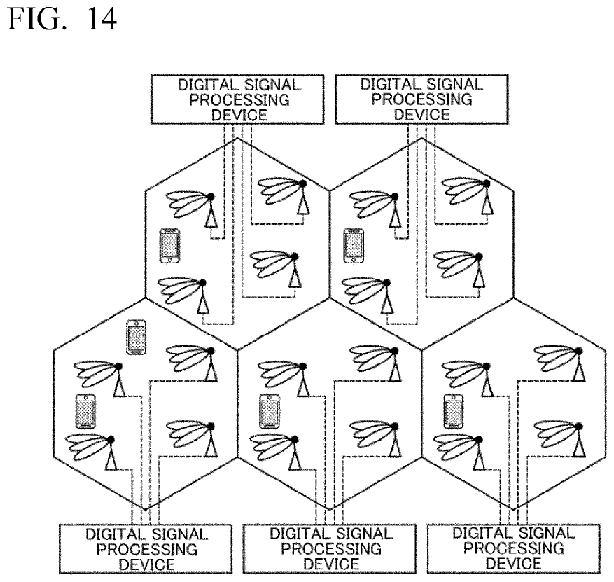

### DESCRIPTION OF EMBODIMENTS

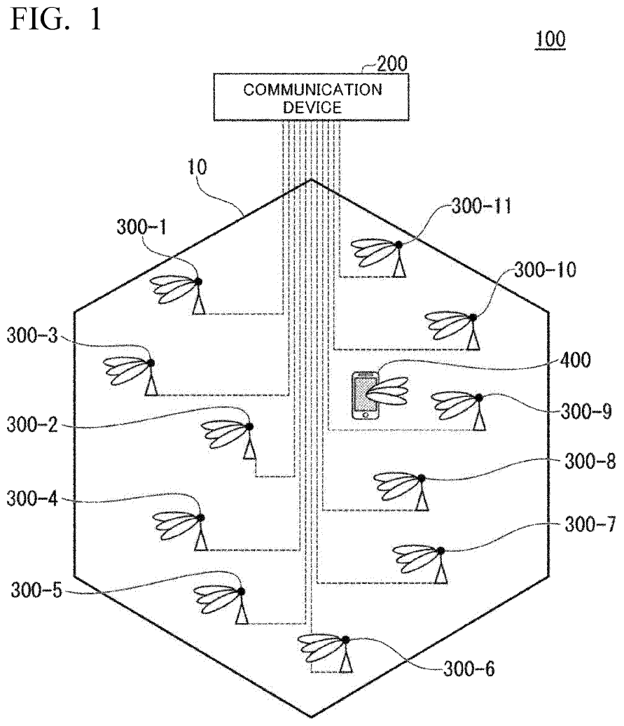

An embodiment of the present invention will be described in detail with reference to the drawings. FIG. 1 is an overall configuration diagram of a distributed antenna system 100 according to an embodiment. The distributed antenna system 100 includes one communication device 200 in one cell 10. Also, the distributed antenna system 100 includes a plurality of base stations 300-1, 300-2, 300-3, 300-4, 300-5, 300-6, 300-7, 300-8, 300-9, 300-10, 300-11 in the cell 10. In FIG. 1, 11 base stations are shown as an example, but the number is not limited to 11 as long as a plurality of base stations is provided.

Hereinafter, each of the base stations 300-1, 300-2, 300-3, 300-4, 300-5, 300-6, 300-7, 300-8, 300-9, 300-10, and 300-11 is any one device will be referred to as a base station 300 unless otherwise distinguished. In the distributed antenna system 100, each base station 300 is connected to a communication device 200.

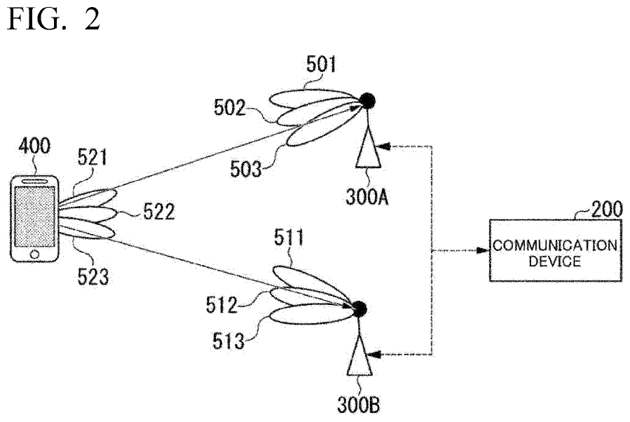

In a distributed antenna system 100, a terminal station 400 can perform MIMO (Multiple Input Multiple Output) transmission using two or more radio streams. FIG. 2 is a diagram showing a connection example between the terminal station 400 and the base station 300. FIG. 2 shows a terminal station 400, base stations 300A and 300B, and a communication device 200. The base stations 300A and 300B indicate any base station of the base station 300.

The terminal station 400 communicates with the base station 300A by using the beam 521 out of the beams 521, 522 and 523. The terminal station 400 communicates with the base station 300B by using the beam 523 out of the beams 521, 522 and 523. The base station 300A communicates with the terminal station 400 by using the beam 502 among the beams 501, 502, 503. The base station 300B communicates with the terminal station 400 by using the beam 512 among the beams 511, 512, 513. Thus, the terminal station 400 performs MIMO transmission using the two radio streams.

In the high frequency band, since the line-of-sight communication is assumed, the direction of the beam used by the base station 300 is highly likely to coincide with the direction of the terminal station 400 viewed from the base station 300. Also, even when a reflected wave is used, the number of reflection paths is small, and the direction of the beam to be used is considered not to be substantially changed. Therefore, when a plurality of base stations 300 perform MIMO transmission toward one terminal station 400, after one base station performs beam selection, the beam used by the other base station is likely to be the same as the beam combined in the past empirical rule.

Specifically, using the example of FIG. 2, assume that the base station 300A selects the beam 502 as a result of the selection process. Note that the selection processing here refers to processing in which the base station 300 selects the beam with the best feedback result (for example, received power, etc.) as the beam for communication with the terminal station 400.

When the base station 300A selects the beam 502, the beam used by the base station 300B is highly likely to be the beam 512. Therefore, the combination information is first stored. The combination information is information in which information uniquely indicating a base station when communicating with a certain terminal station 400 and information uniquely indicating a beam to be transmitted in the base station are provided for each base station. For example, in the case of FIG. 2 (base station 300A, beam 502), (base station 300B, beam 512) corresponds to combination information. The beam shown in the combination information is the beam having the best feedback result. Therefore, the combination information is information for performing the best communication with a certain terminal station 400.

Such combination information is stored, and when the beam 502 is selected as the beam used by the base station 300A, the stored combination information is referred to, and the beam used by the base station 300B is made a beam 512. Thus, when the base station 300B originally performs selection processing by each of the beams 511, 512, 513, the selection processing of only the beam 512 is sufficient, thus, the increase of overhead can be suppressed.

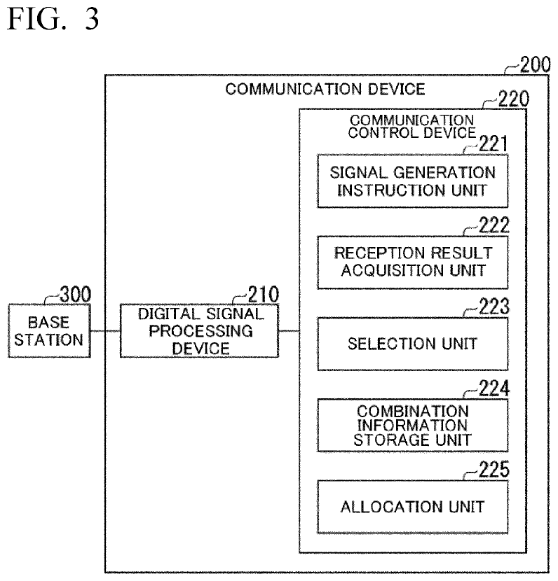

FIG. 3 is a block diagram showing the configuration of the communication device 200. The communication device 200 is composed of a digital signal processing device 210 and a communication control device 220. The digital signal processing device 210 is connected to the base station 300 and the communication control device 220. The digital signal processing device 210 transmits a signal to the base station 300 and outputs a signal received from the base station 300 to the communication control device 220 in accordance with an instruction from the communication control device 220.

The communication control device 220 is composed of a signal generation instruction unit 221, a reception result acquisition unit 222, a selection unit 223, a combination information storage unit 224 and an allocation unit 225.

The signal generation instruction unit 221 outputs an instruction to generate various signals and information specifying a base station 300 to which the various signals are transmitted to the digital signal processing device 210. The designated base station 300 generates a signal and transmits the generated signal to the terminal station 400.

The reception result acquisition unit 222 acquires various information from the terminal station 400. For example, the reception result acquisition unit 222 acquires the feedback result received from the terminal station 400 decoded by the digital signal processing device 210 and a transmission beam ID uniquely indicating a beam corresponding to the feedback result. A reception result acquisition unit 222 measures reception power of a reception beam search signal transmitted from a terminal station 400, and acquires a reception beam ID whose reception result is the best.

A selection unit 223 selects a beam for communicating with a terminal station in some of the plurality of base stations. The combination information storage unit 224 stores the combination information. An allocation unit 225 allocates candidate beams associated in advance with the beams selected by the selection unit 223 as candidate beams for communication with terminal stations in base stations other than some base stations.

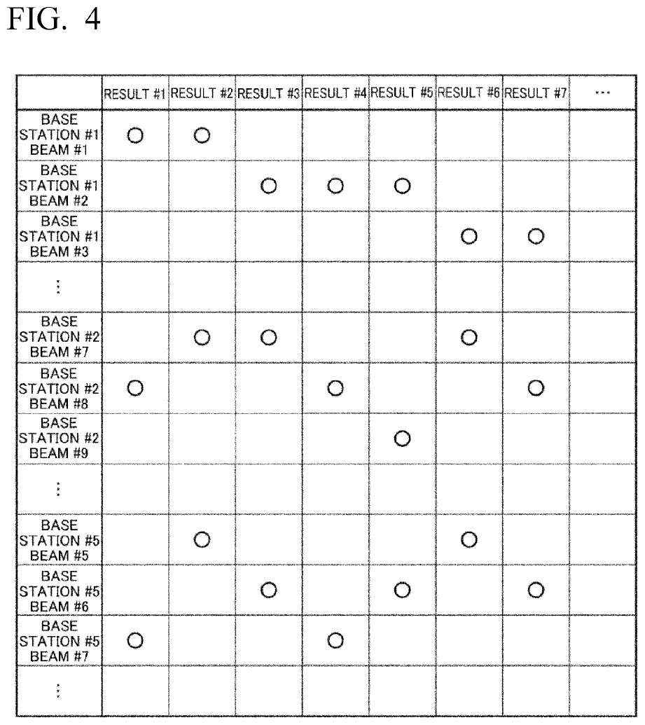

FIG. 4 is a diagram showing an example of combination information. The combination information indicates the combination of beams used at some base stations, and beams used at other base stations other than some base stations when the beam is used by some of the base stations.

As shown in FIG. 4, the combination information includes information uniquely indicating a base station (base station #1, base station #5, etc.) and information uniquely indicating a beam transmitted by the base station (beam #2, beam #9, etc.) is information provided for each base station. “Result #⋅” is information for specifying a plurality of combination information.

In FIG. 4, taking result #1 as an example, some base stations are base station #1, and base stations other than some base stations are base station #2 and base station #5, and then a combination of beam #1 used by station #1, beam #8 used by base station #2 when the beam was used by base station #1, and beam #7 used by base station #5 is shown.

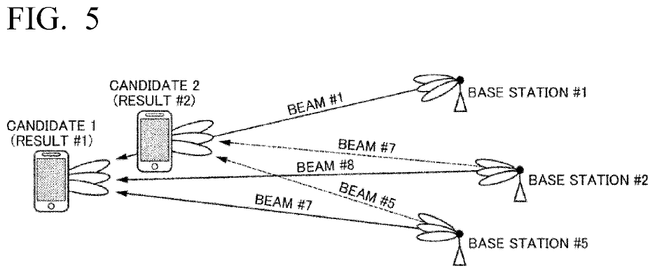

FIG. 5 is a diagram showing a beam example when beam #1 is selected as the beam for base station #1 by selection unit 223. When beam #1 is selected as the beam of base station #1 by selection unit 223, result #1 and result #2 correspond to the combination information.

Then, for a candidate beam of the base station #2, the allocation unit 225 allocates a beam #8 associated in advance with the beam selected by the selection unit 223 in the result #1. For a candidate beam of the base station #2, an allocation unit 225 allocates a beam #7 associated in advance with the beam selected by the selection unit 223 in the result #2. Therefore, the base station #2 sets the beam #7 and the beam #8 as candidates.

Similarly, the allocation unit 225 allocates, as a candidate beam of the base station #5, a beam #7 associated in advance with the beam selected by the selection unit 223 in the result #1. For a candidate beam of the base station #2, an allocation unit 225 allocates a beam #5 associated in advance with the beam selected by the selection unit 223 in the result #2. Therefore, the base station #5 sets the beam #5 and the beam #7 as candidates.

Thus, since in the base station #2, the beam selection processing for beams other than the beam #7 and the beam #8 is not required, and in the base station #5, the beam selection processing for beams other than the beam #5 and the beam #7 is not required, overhead can be suppressed.

Based on the above-described configuration, the flow of processing by the communication control device 220 will be described with reference to four flowcharts. In the following flow chart, the number of base stations included in one cell is set to N. In order to distinguish the N base stations, they are expressed as “base station (⋅)”. The base stations (⋅) are from base station (1) to base station (N).

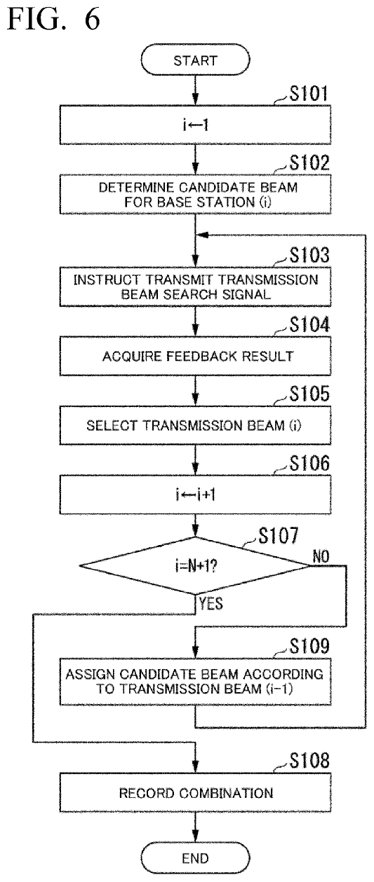

FIG. 6 is a flow chart showing the flow of processing for allocating transmission beams of a plurality of base stations 300 to one terminal station 400. The combination information in the flow chart shown in FIG. 6 is composed of information uniquely indicating the base station 300 when one terminal station 400 communicates with the N base stations 300 and information uniquely indicating a beam transmitted by the base station 300 to the one terminal station 400.

The communication control device 220 initializes a loop counter i to 1 (step S101). A loop counter i is a counter for counting the number N of base stations included in one cell. The communication control device 220 determines candidate beams for the transmission beam search signal of the base station (i) (step S102). At this step S102, since i=1, the candidate beam for the base station (1) is determined.

As described above, once the beam of the first base station is selected, candidate beams of other base stations are assigned according to the combination information. Therefore, since the candidate beams of the first transmission beam search signal cannot use the candidate beam allocation based on the combination information, normally all beams are used, but some beams may be used. When the candidate beams are some of the beams, the candidate beams with relatively wide beam widths may be selected in advance, and the beams with further narrow beam widths may be used as the candidate beams among the selected candidate beams. Alternatively, the azimuth of the terminal station may be roughly estimated by sensing using position information or images, and only beams in the vicinity thereof may be used as candidate beams.

The location information includes location information by GPS obtained from terminal stations and ranging information using the RTT (Round Trip Time) (distance measurement by calculating the round trip time from the exchange of signals between the base station and the terminal station) of communication radio waves. The sensing by an image is a method for acquiring the position of a terminal station from a camera image of a town or the like by image recognition.

The communication control unit 220 instructs the digital signal processing device 210 to transmit a transmission beam search signal that has become a candidate beam for the base station (i) (step S103). As a result, digital signal processing device 210 instructs base station (i) to transmit a transmission beam search signal. When the base station (i) transmits a transmission beam search signal to the terminal station 400, the terminal station 400 measures the received power of each beam of the transmission beam search signal and feeds back the result to the base station (i). The communication control device 220 acquires the feedback result via the digital signal processing device 210 (step S104). After obtaining the feedback results for all the candidate beams, the communication control device 220 selects the candidate beam with the best feedback result, as the transmission beam (i).

The communication control device 220 increments the counter i (step S106) and determines whether the counter i is equal to N+1 (step S107). This step S107 is the process of determining whether or not the process has been performed for all the terminal stations 400.

If the counter i is different from N+1 (step S107: NO), the communication control device 220 refers to the combination information as a candidate beam for the base station (i) for communicating with the terminal station 400, and allocates the candidate beam associated in advance with a transmission beam (i−1). Specifically, taking result #1 and result #2 in FIG. 4 as an example, base station (1) corresponds to base station #1, and beam #1 corresponds to transmission beam (1). Base station #2 corresponds to base station (2), and beam #8 and beam #7 are allocated as candidate beams to base station #2.

When the candidate beams are allocated, the communication control device 220 instructs the digital signal processing device 210 to transmit the transmission beam search signal for the allocated candidate beams in step S103 (step S102).

As described above, in the case of result #1 and result #2, beam #8 and beam #7 are assigned to base station (2), but there may be cases where there are no candidate beams to assign. In this case, steps S103 to S105 following step S109 are skipped, and step S106 is performed. As a result, an increase in overhead can be suppressed.

If the counter i is equal to N+1 (step S107: YES), the process has been performed for all the terminal stations 400, so the communication control device 220 records the combination information (step S108) and ends the process.

Note that the combination information recorded in step S108 may be the same as the combination information referred to in step S109. Therefore, when the combination information is updated or when all the combination information of the candidate beams is not learned (when all the combination information has not been obtained), instead of searching only the candidate beams stored in the combination information storage unit 224, the beams stored in the combination information storage unit 224 may be searched preferentially, and beams not stored in the combination information storage unit 224 may also be searched.

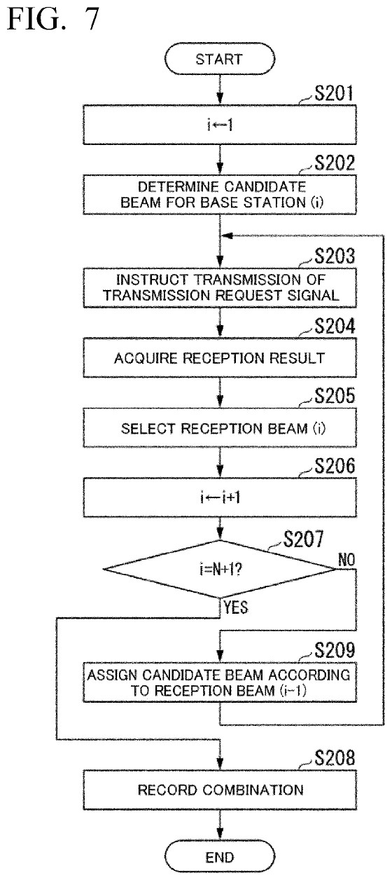

FIG. 7 is a flow chart showing the flow of processing for allocating the reception beams of the plurality of base stations 300 to one terminal station 400. The combination information in the flow chart shown in FIG. 7 is composed of information uniquely indicating the base station 300 when one terminal station 400 communicates with the N base stations 300 and information uniquely indicating the beam received by the base station 300 from the one terminal station 400.

The communication control device 220 initializes the loop counter i to 1 (step S201). A loop counter i is a counter for counting the number N of base stations included in one cell. The communication controller 220 determines candidate beams for the reception beam search of the base station (i) (step S202). At this step S202, since i=1, the candidate beam for the base station (1) is determined.

The candidate beam of the first reception beam search signal cannot utilize the allocation of the candidate beam based on the combination information, so that the entire beam is normally used, but some of the beam may be used. When the candidate beams are some of the beams, the candidate beams with relatively wide beam widths may be selected in advance, and the beams with further narrow beam widths may be used as the candidate beams among the selected candidate beams. Further, as described above, the azimuth of the terminal station may be estimated generally by sensing by position information or an image, and only the beam in the vicinity thereof may be used as a candidate beam.

The communication control device 220 instructs the digital signal processing device 210 to transmit a transmission request signal for requesting the terminal station 400 to transmit reception beam search signals for the number of beams that become candidate beams of the base station (i) (step S203). Thus, the digital signal processing device 210 instructs the base station (i) to generate a transmission request signal. The base station (i) transmits a transmission request signal to the terminal station 400, thereby a reception beam search signal is transmitted from the terminal station 400. The communication control device 220 acquires a reception result (reception power or the like) of the reception beam search signal measured by the digital signal processing device 210 (step S204). When the reception results of the reception beam search signals for all the candidate beams are acquired, the communication control device 220 selects the candidate beam whose reception results are the best as the reception beam (i).

The communication control device 220 increments the counter i (step S206) and determines whether the counter i is equal to N+1 (step S207). This step S207 is a process for determining whether or not the process has been performed for all the terminal stations 400.

When the counter i is different from N+1 (step S207: NO), the communication control device 220 refers to the combination information as a candidate beam of the base station (i) for communicating with the terminal station 400, and allocates the candidate beam associated in advance with a reception beam (i−1).

When the candidate beams are allocated, the communication control device 220 instructs the digital signal processing device 210 to transmit the transmission request signal for the allocated candidate beams in step S203 described above (step S202).

When there is no candidate beam to be allocated, steps S203 to S205 next to the step S209 is skipped and a step S206 is performed. As a result, an increase in overhead can be suppressed.

If the counter i is equal to N+1 (step S207: YES), the process has been performed for all the terminal stations 400, so the communication control device 220 records the combination information (step S208) and ends the process.

Note that the combination information recorded in step S208 may be the same as the combination information referred to in step S209. Therefore, when the combination information is updated or when all the combination information of the candidate beams is not learned (when all the combination information has not been obtained), only the candidate beams stored in the combination information storage unit 224 are not searched but the beams in the combination information storage unit 224 are searched preferentially, the beam which is not in the combination information storage unit 224 may also be searched.

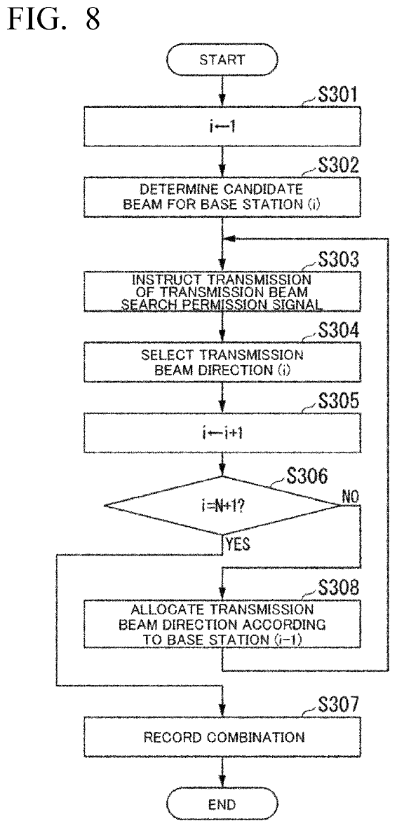

FIG. 8 is a flow chart showing the flow of processing for allocating the beam direction of the beam transmitted by one terminal station 400 to a plurality of base stations 300. The combination information in the flow chart shown in FIG. 8 is composed of information uniquely indicating the terminal station 400 when one terminal station 400 communicates with the N base stations 300, and information uniquely indicating the beam direction of the beam transmitted by the terminal station 400 to the plurality of base stations 300. In the description of this flowchart, the beam direction of the beam to be transmitted may be expressed as the transmission beam direction.

The communication control device 220 initializes the loop counter i by 1 (step S301). The loop counter I is a counter for counting the number N of base stations included in one cell. The communication control device 220 determines a candidate beam of a transmission beam search signal to the base station (i) (step S302). In this step S302, since i=1 is used, a candidate beam of the base station (1) is determined.

The candidate beam of the first transmission beam search signal cannot utilize the allocation of the candidate beam based on the combination information, so that the candidate beam is usually a whole beam but a part of the beam may be used. When the candidate beams are some of the beams, the candidate beams with relatively wide beam widths may be selected in advance, and the beams with further narrow beam widths may be used as the candidate beams among the selected candidate beams. Further, as described above, the azimuth of the terminal station may be estimated generally by sensing by position information or an image, and only the beam in the vicinity thereof may be used as a candidate beam.

The communication control device 220 instructs the digital signal processing device 210 to transmit a transmission beam search signal permission signal for permitting transmission of the transmission beam search signal (step S303). As a result, the digital signal processing device 210 instructs the base station (i) to transmit the transmission beam search signal permission signal. The transmission beam search permission signal in the step S303 is a transmission beam search signal which becomes a candidate beam to the base station (i) in the step S301 or a signal for permitting transmission of a transmission beam search signal in a transmission beam direction allocated in a step S308 described later.

The base station (i) transmits a transmission beam search signal permission signal to the terminal station 400, and the terminal station 400 transmits a transmission beam search signal. The base station 300 selects the best transmission beam direction (i) of the terminal station 400 for the base station (i) from the transmission beam search signal transmitted from the terminal station 400 (step S304). However, since the direction of the terminal station 400 changes, the best transmission beam direction (i) is determined based on the best beam ID (uniquely indicating the transmission beam) such as the highest received power at the base station (i) and gyroscope information acquired from the terminal station 400 and the like, and the beam ID is fed back to the terminal station 400, so that the terminal station can select the transmission beam.

The communication control device 220 increments the counter i (step S305) and determines whether the counter i is equal to N+1 (step S306). This step S306 is a process for determining whether or not the process has been performed for all base stations 300.

If the counter i is different from N+1 (step S306: NO), the communication control device 220 refers to the combination information as the transmission beam direction of the terminal station 400 for communicating with the base station (i), and allocates the transmission beam direction associated in advance with the base station (i−1).

When the transmission beam direction is allocated, the communication control device 220 instructs a digital signal processing device 210 to transmit a transmission beam search signal permission signal for permitting transmission of a transmission beam search signal in the transmission beam direction in step S303 described above (step S303).

If there is no transmission beam direction to be assigned, steps S303 and S304 following step S308 are skipped, and step S305 is performed. As a result, an increase in overhead can be suppressed.

When the counter i is equal to N+1 (step S306: YES), and since the processing is performed for all the base stations 300, the communication control device 220 records the combination information (step S307), and terminates the processing.

Note that the combination information recorded in step S307 may be the same as the combination information referred to in step S308. Therefore, when updating the combination information, or when all the combination information of the transmission beam directions has not been learned (when all the combination information has not been obtained), instead of searching only the transmission beam directions stored in the combination information storage unit 224, transmission beam directions stored in the combination information storage unit 224 may be searched preferentially, and beams not stored in the combination information storage unit 224 may also be searched.

Although the communication control device 220 permits the transmission of the transmission beam search signal of the terminal station 400, the present invention is also applicable to the case where the terminal station 400 performs the transmission beam search with a specific signal from the base station 300 as a trigger or the case where the terminal station 400 performs the transmission beam search spontaneously.

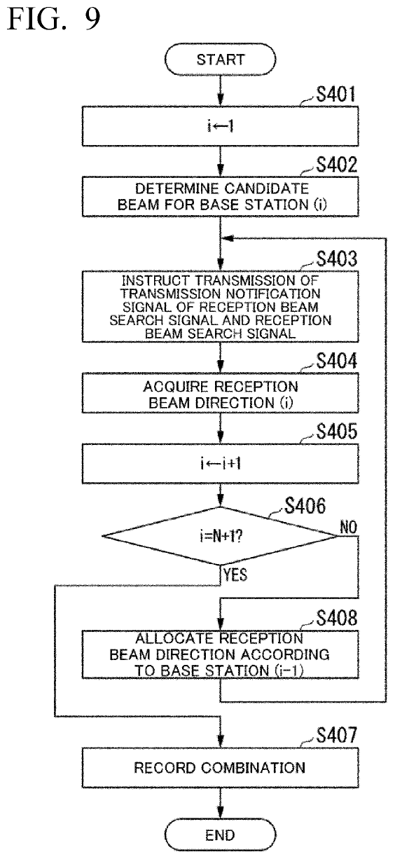

FIG. 9 is a flow chart showing the flow of processing for allocating the beam direction of the beam received by one terminal station 400 to a plurality of base stations 300. The combination information in the flow chart shown in FIG. 9 is composed of information uniquely indicating the terminal station 400 when one terminal station 400 communicates with the N base stations 300, and information uniquely indicating the beam direction of the beam received from the plurality of base stations 300 by the terminal station 400. In the description of this flowchart, the beam direction of the beam to be received may be expressed as the reception beam direction.

The communication control device 220 initializes the loop counter i to 1 (step S401). A loop counter i is a counter for counting the number N of base stations included in one cell. The communication controller 220 determines candidate beams for the reception beam search signal for the base station (i) (step S402). At this step S402, since i=1, the candidate beam for the base station (1) is determined.

Since the candidate beams of the first reception beam search signal cannot use the candidate beam allocation based on the combination information, all beams are normally used, but some beams may be used. When the candidate beams are some of the beams, the candidate beams with relatively wide beam widths may be selected in advance, and the beams with further narrow beam widths may be used as the candidate beams among the selected candidate beams. Further, as described above, the azimuth of the terminal station may be estimated generally by sensing by position information or an image, and only the beam in the vicinity thereof may be used as a candidate beam.

The communication control device 220 instructs the digital signal processing device 210 to transmit the transmission notification signal of the reception beam search signal and the reception beam search signal (step S403). As a result, the digital signal processing device 210 instructs the base station (i) to transmit the reception beam search signal transmission notification signal and the reception beam search signal. The reception beam search signal in step S403 is either the reception beam search signal that was the candidate beam for the base station (i) in step S401 or the reception beam search signal in the reception beam direction assigned in step S408, which will be described later.

A base station (i) transmits a transmission notification signal of a reception beam search signal and a reception beam search signal. The terminal station 400 measures the reception power of the reception beam search signal transmitted from the base station (i) at the timing notified by the transmission notification signal, and the terminal station 400 selects the best reception beam ID and the best receive beam direction (i) from the reception result of the reception beam search signal and feeds them back to the base station (i). The communication control device 220 obtains the best reception beam direction (i) of the terminal station 400 with respect to the base station (i) from the feedback result of the reception beam search signal via the digital signal processing device 210 (step S404). However, since the direction of the terminal station 400 changes, the best reception beam direction (i) is obtained based on the best beam ID (uniquely indicating the reception beam) such as the highest received power, and gyroscope information acquired by the terminal station 400 and the like.

The communication control device 220 increments the counter i (step S405) and determines whether the counter i is equal to N+1 (step S406). This step S406 is a process for determining whether or not the process has been performed for all the base stations 300.

If the counter i is different from N+1 (step S406: NO), the communication control device 220 refers to the combination information as the receiving beam direction of the terminal station 400 for communicating with the base station (i), and allocates a reception beam direction associated in advance with the base station (i−1).

When the reception beam direction is assigned, communication control device 220 instructs digital signal processing device 210 to transmit a reception beam search signal in the reception beam direction in step S403 described above (step S403).

If there is no reception beam direction to be assigned, step S408 is followed by step S403 and step S404 are skipped and step S405 is performed. As a result, an increase in overhead can be suppressed.

When the counter i is equal to N+1 (step S406: YES), the process has been performed for all base stations 300, so the communication control device 220 records the combination information (step S407) and ends the process.

Note that the combination information recorded in step S407 may be the same as the combination information referenced in step S408. Therefore, when updating the combination information, or when all the combination information of the reception beam directions has not been learned (when all the combination information has not been obtained), only the reception beam directions stored in the combination information storage unit 224 are Instead of searching, the reception beam directions stored in the combination information storage unit 224 may be searched preferentially, and beams not stored in the combination information storage unit 224 may also be searched.

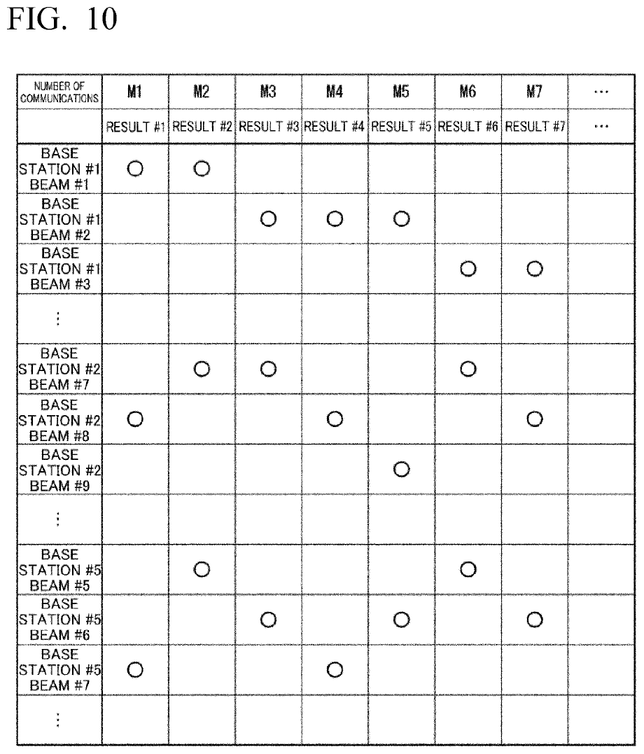

Next, another example of combination information will be described. FIG. 10 shows an example of combination information indicating the number of times of communication in addition to the combination information shown in FIG. 4. That is, the combination information shown in FIG. 10 further indicates the number of times of communication having performed by combining beams used at some of base stations, and beams used at other base stations other than some of the base stations while some of the base stations use the beams.

As shown in FIG. 10, the number of times of communication (M1 to M7) is provided for each result. For example, the number of times of communication of the result #1 is M1. By further indicating the number of communications in this way, for example, when beam #1 is selected in base station #1, the magnitudes of the number of communications M1 and M2 for corresponding result #1 and result #2 are compared, It is determined that the candidate with the larger number of communications has a higher probability of being the candidate corresponding to the current communication, and the candidate with the larger number of communications is selected as the first candidate. By doing so, it becomes easier to find an appropriate candidate, and overhead can be further suppressed.

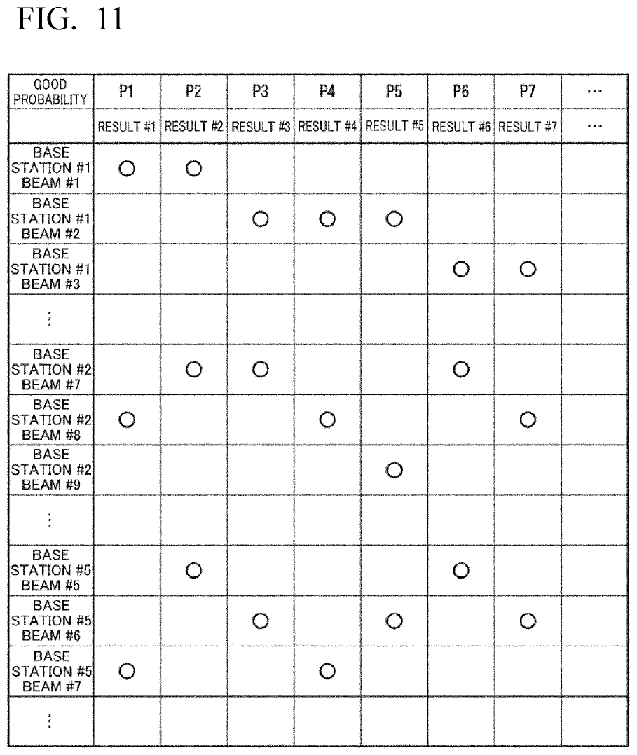

FIG. 11 shows an example of combination information indicating a probability that a predetermined condition is satisfied in addition to the combination information shown in FIG. 4. That is, the combination information shown in FIG. 11 further indicates the probability of satisfying a predetermined condition of the communication having performed by combining beams used at some base stations, and beams used at other base stations other than some base stations when the beam is used by some of the base stations.

In FIG. 11, a condition that the communication result was good is used as a predetermined condition. It should be noted that the result of communication is satisfactory means that the received power of all beams used in communication is equal to or higher than a predetermined value, and the capacity at the time of MIMO transmission is equal to or higher than a predetermined value, for example. As shown in FIG. 11, a good probability (P1 to P7) is provided for each result. For example, a good probability at the result #1 is P1. By further showing the good probability, for example, when a beam #1 is selected in a base station #1, the magnitude of the good probabilities P1, P2 of the corresponding result #1 and the result #2 is compared, and it is determined that the probability that the candidate having the large good probability becomes good in this communication is higher, and the candidate having a higher probability of good is selected as the first candidate. By doing so, it becomes easier to find an appropriate candidate, and overhead can be further suppressed.

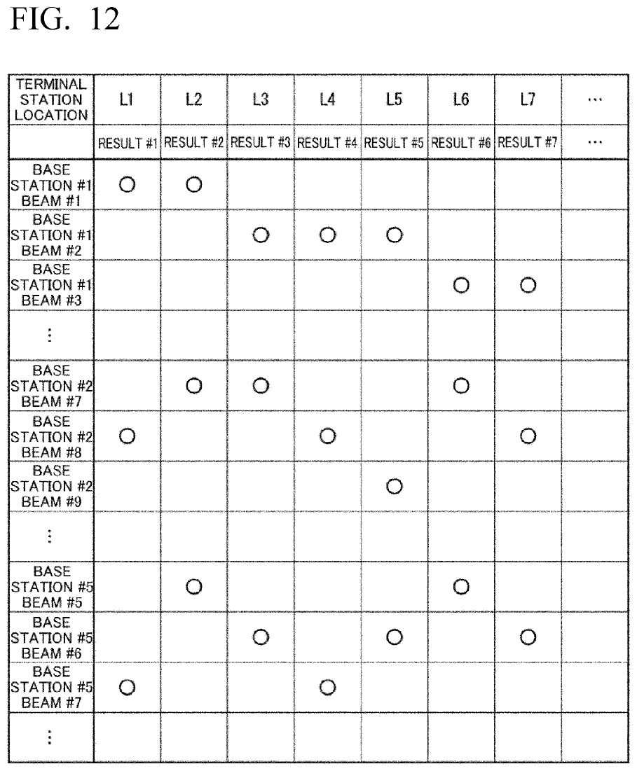

FIG. 12 shows an example of combination information further indicating the position of the terminal station in addition to the combination information shown in FIG. 4. That is, the combination information shown in FIG. 12 further indicates the position of the terminal station in the communication having performed by combining beams used at some base stations, and beams used at other base stations other than some base stations when the beam is used by some of the base stations.

As shown in FIG. 12, terminal station positions (L1 to L7) are provided for each result. Note that the terminal station position L =(latitude, longitude). For example, the terminal station position in result #1 is L1. By further indicating the terminal station position, for example, when a beam #1 is selected in a base station #1, the position is acquired from the terminal station, it is determined that a candidate closer to one of the terminal station positions L1 and L2 of the corresponding result #1 and the result #2 is a candidate corresponding to this communication is higher, and the closer candidate is set as the first candidate. By doing so, it becomes easier to find an appropriate candidate, and overhead can be further suppressed. It should be noted that reception power information, for example, may be indicated instead of the terminal station position. This is because there is a correlation between the received power and the distance between the transmitter and receiver in high frequency band wireless communication, which is mainly line-of-sight communication, such as when the received power is high, the transmission and reception distance is short.

The communication control device 220 may be configured using a processor such as a CPU (Central Processing Unit) and a memory. In this case, communication control device 220 functions as communication control device 220 by the processor executing a program. Note that all or part of each function of the communication control device 220 may be realized using hardware such as an ASIC (Application Specific Integrated Circuit), a PLD (Programmable Logic Device), or an FPGA (Field Programmable Gate Array). The above program may be recorded on a computer-readable recording medium. Computer-readable recording media including portable media are storage device such as flexible disks, magneto-optical disks, ROMs, CD-ROMS, semiconductor storage devices (SSD: Solid State Drive), hard disks and semiconductor storage built into computer systems. The above program may be transmitted via telecommunication lines.

Although the embodiments of the present invention have been described in detail with reference to the drawings, specific configurations are not limited to these embodiments, and designs and the like within a range that does not deviating from the gist of the present invention are also included.

### INDUSTRIAL APPLICABILITY

The present invention is applicable to communication control devices in distributed antenna systems.

### REFERENCE SIGNS LIST

10 . . . cell, 100 . . . distributed antenna system, 200 . . . communication device, 210 . . . digital signal processing device, 220 . . . communication control device, 221 . . . signal generation instruction unit, 222 . . . reception result acquisition unit, 223 . . . selection unit, 224 . . . combination information storage unit, 225 . . . allocation unit, 300, 300-1, 300-2, 300-3, 300-4, 300-5, 300-6, 300-7, 300-8, 300-9, 300-10, 300-11, 300A, 300B . . . base station, 400 . . . terminal station

1. A control method, comprising:
a selection step for selecting a beam for communication with a terminal station at some of a plurality of base stations in a distributed antenna system; and
an allocation step of allocating a candidate beam associated in advance with the beam selected by the selection step as the candidate beam in which base stations other than some of the base stations perform communication with terminal stations.

2. The control method according to claim 1, wherein
the allocation step allocates a candidate beam associated in advance with the beam selected by the selection step by referring to combination information indicating a combination between beams used by the some of the base stations, and a beam used at other base stations other than some of the base stations when the beam is used by some of the base stations.

3. The control method according to claim 2, wherein the combination information further indicates a number of times that communication is performed with a combination of beams used by the some of the base stations, and a beam used at base stations other than some of the base stations when the beam is used by some of the base stations.

4. The control method according to claim 2, wherein the combination information further indicates a probability of satisfying a predetermined condition when communication is performed with a combination of beams used by the some of the base stations, and a beam used at base stations other than some of the base stations when the beam is used by some of the base stations.

5. The control method according to claim 2, wherein the combination information further indicates the position of the terminal station when communication is performed with a combination of beams used by the some of the base stations, and a beam used at base stations other than some of the base stations when the beam is used by some of the base stations.

6. A control method, comprising:
a selection step for selecting a direction of a beam for communication with a terminal station at some of a plurality of base stations in a distributed antenna system; and
an allocation step of allocating a direction of a beam associated in advance with the direction of the beam selected by the selection step as the candidate direction of the beam in which base stations other than some of the base stations perform communication with terminal stations.

7. The control method according to claim 6, wherein the allocation step allocates a candidate of a direction of a beam associated in advance with the direction of the beam selected by the selection step by referring to combination information indicating a combination between a direction of a beam used for the some of the base stations, and a direction of a beam for other base stations other than some of the base stations when the direction of the beam is used for some of the base stations.

8. A communication control device, comprising:
a selection unit for selecting a beam for communication with a terminal station at some of a plurality of base stations in a distributed antenna system; and
an allocation unit of allocating a candidate beam associated in advance with the beam selected by the selection unit as the candidate beam in which base stations other than some of the base stations perform communication with terminal stations.
